(19) United States
(12) Patent Application Publication
(10) Pub. No.: US 2005/0092954 A1
(43) Pub. Date: May 5, 2005

(54) Plug valve adjustment means

(76) Inventor: Nicolas Paul, Varennes (CA)

Correspondence Address: BROUILLETTE KOSIE PRINCE;25th Floor, 1100 Rene-Levesque Boulevard West, Montreal, QC, H3B 5C9, CA

(21) Appl. No.: 10/811,497

(22) Filed: Mar. 29, 2004

(30) Foreign Application Priority Data
Oct. 31, 2003 (CA) 2,447,866

(51) Int. Cl. F16K 31/44

(52) U.S. Cl. 251/251

(57) ABSTRACT

A rotary plug valve has a plug portion which is rotatably fitted within a valve body. This plug portion of the valve is joined by a stem or shaft portion which extends out of the valve body to interact with an actuator and transmit torque to the plug portion. Pressure needs to be applied to the plug portion to insure a proper closure. The invention relates to a mechanism to provide such pressure adjustment that uses only one screw that is positioned on the front of the valve cover for easy access. The force generated by the screw is transposed into a vertical force by a cam. The multiple faces of the cam are used to transmit the force vertically and will maintain the mechanism in a straight position.

### BACKGROUND

It is common and usual practice in sealing the top portion of rotary plug valves to use a top seal that seals against media leakage while simultaneously accommodating rotational movement of the valving element relative to a valve body. A rotary plug valve has a plug portion which is rotatably fitted within a valve body. This plug portion of the valve is joined by a stem or shaft portion which extends out of the valve body to interact with an actuator and transmit torque to the plug portion. This torque is used to rotate the plug portion within the valve body and to move a passageway in the plug portion of the valve in and out of registry with a flow passage extending through the valve body.

In plug valves, it is common practice to seal the top of the valve with a centrally apertured diaphragm with the shaft portion of the valve extending through the central aperture of the top seal. The mechanism for the adjustment of plug valves normally turns around the compression of two sealing parts to prevent leakage. These mechanisms involve normally a plurality of tightening bolts or screws (usually three but sometimes two).

Examples of such valves can be is seen in U.S. Pat. Nos. 3,235,272 (Smith); 4,159,818 and 4,475,713 (Reed et al.).

While all of the above mentioned sealing arrangements have been highly satisfactory, they are not without their attendant disadvantages. For example, the tightening bolts or screws often need to be screwed simultaneously to prevent unwanted side loading on the system. Furthermore, these bolts or screws are difficult to access with tools, especially in case of toxic leakage. As a result, these screws are rarely adjusted which reduces the effective life of the valve.

It is thus an object of the present invention to provide plug valve adjustment means which uses a single screw that is positioned on the front of the cover for easy access. It is a further object of the present invention to provide a top valve seal which provides for ease of adjustment when the valve is serviced in the field and which does not require special tools.

It is yet another object of the present invention to provide plug valve adjustment means which comprises a cam.

### SUMMARY OF THE INVENTION

Our mechanism uses only one screw that is positioned on the front of the cover for easy access. The force generated by the screw is transposed into a vertical force by a cam. The multiple faces of the cam are used to transmit the force vertically and will maintain the mechanism in a straight position.

Preferably, the top of the cam is used to indicate it's position. As the cam is rotated, an arrow will point it's position relative to the graduation on the cover. Also as the cam is rotated it's vertical motion downward can be used as an indication of the adjustment measured by the part of the cam that's outside the cover, it indicates the amount of compression that's left before the maximum compression is reached (when the top face of the cam mate the top of the cover).

The base of the cam can be shaped to fit any type of seal or purpose; in this case, we can put any angle to redistribute the compression in radial and axial direction on the seal.

### BRIEF DESCRIPTION OF THE DRAWINGS

Other objects and advantages of the invention will become apparent when reading the following detailed description and upon reference to the drawings, in which:

FIG. 1A is a perspective view of a plug valve made in accordance with the present invention.

FIG. 1B is a perspective view of the plug valve shown in FIG. 1A on which a mounting bracket is attached.

FIG. 2A is a fragmentary perspective view of the plug valve shown in FIG. 1A.

FIG. 2B is another fragmentary perspective of the plug valve shown in FIG. 1A.

FIG. 3 is a top view of the plug valve shown in FIG. 1A.

FIG. 4 is a side view of the plug valve shown in FIG. 1A.

FIG. 5 is an end view of the plug valve shown in FIG. 1A.

FIG. 6A is a partial top view of the plug valve shown in FIG. 1A.

FIG. 6B is a fragmentary perspective view of the plug valve shown in FIG. 1A.

FIG. 7 is a cross sectional view of the plug valve shown in FIG. 6A.

FIG. 8 is a perspective view of the cover and of the adjustment cam (unassembled) of the plug valve shown in FIG. 1A.

FIG. 9 is a top view of the cover and of the adjustment cam shown in FIG. 8.

FIG. 10 is a bottom view of the cover and of the adjustment cam shown in FIG. 8.

FIG. 11 is a bottom perspective view of the cover and of the adjustment cam shown in FIG. 8.

FIG. 12A is a bottom perspective view of the cover and of the adjustment cam shown in FIG. 8 (assembled and in a first position).

FIG. 12B is a bottom perspective view of the cover and of the adjustment cam shown in FIG. 8 (assembled and in a second position).

FIG. 12C is a bottom perspective view of the cover and of the adjustment cam shown in FIG. 8 (assembled and in a third position).

FIG. 13 is a fragmentary cross sectional view of a the cover and top seal of the plug valve shown in FIG. 1A.

While the invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

### DETAILED DESCRIPTION OF THE PREFERRED EMBODIMENT

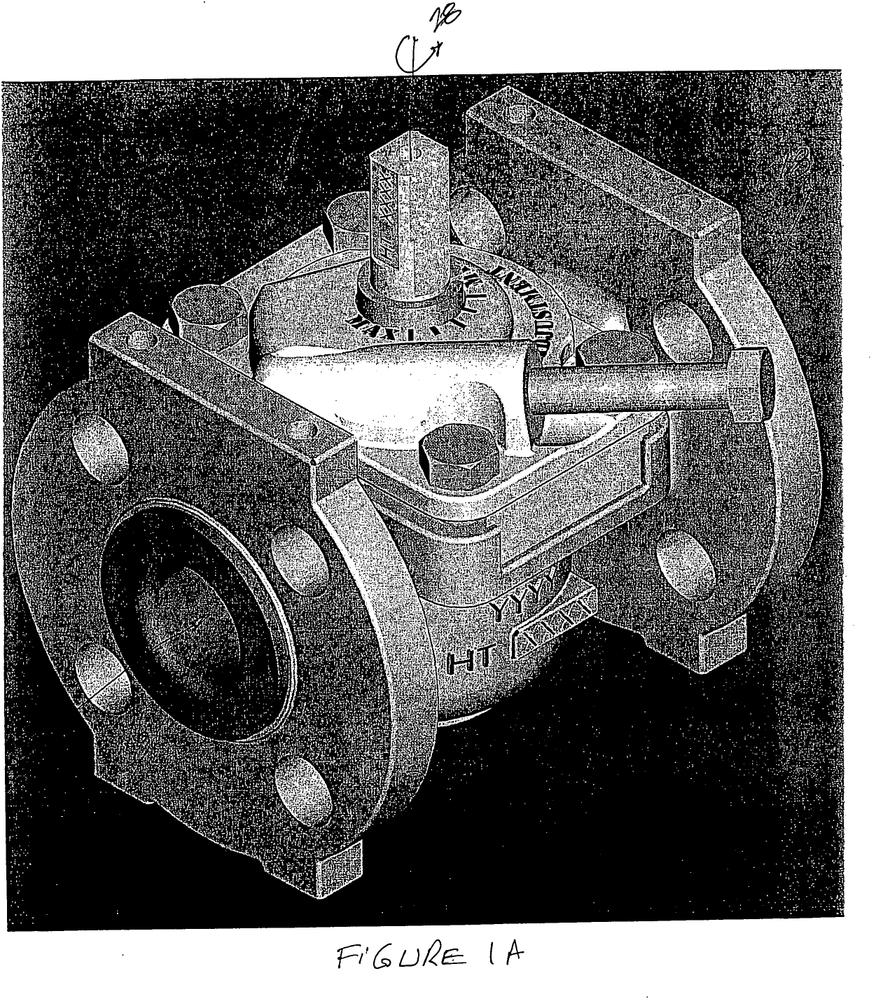

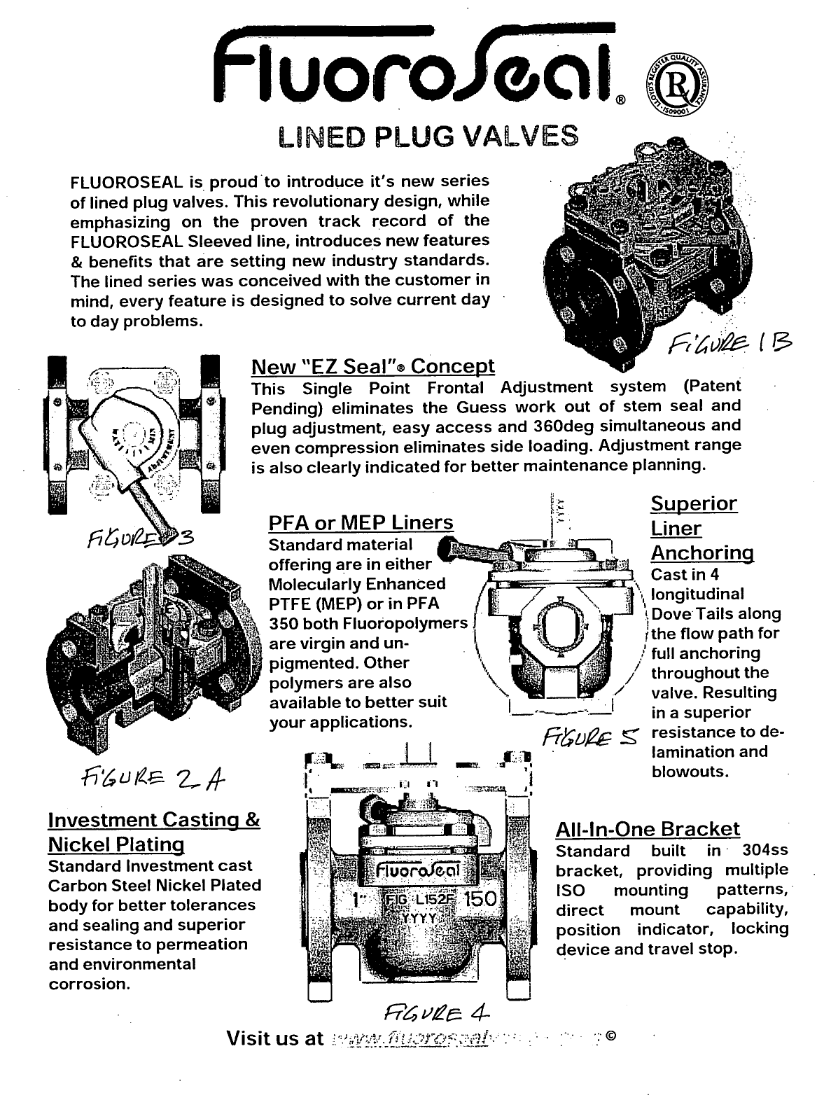

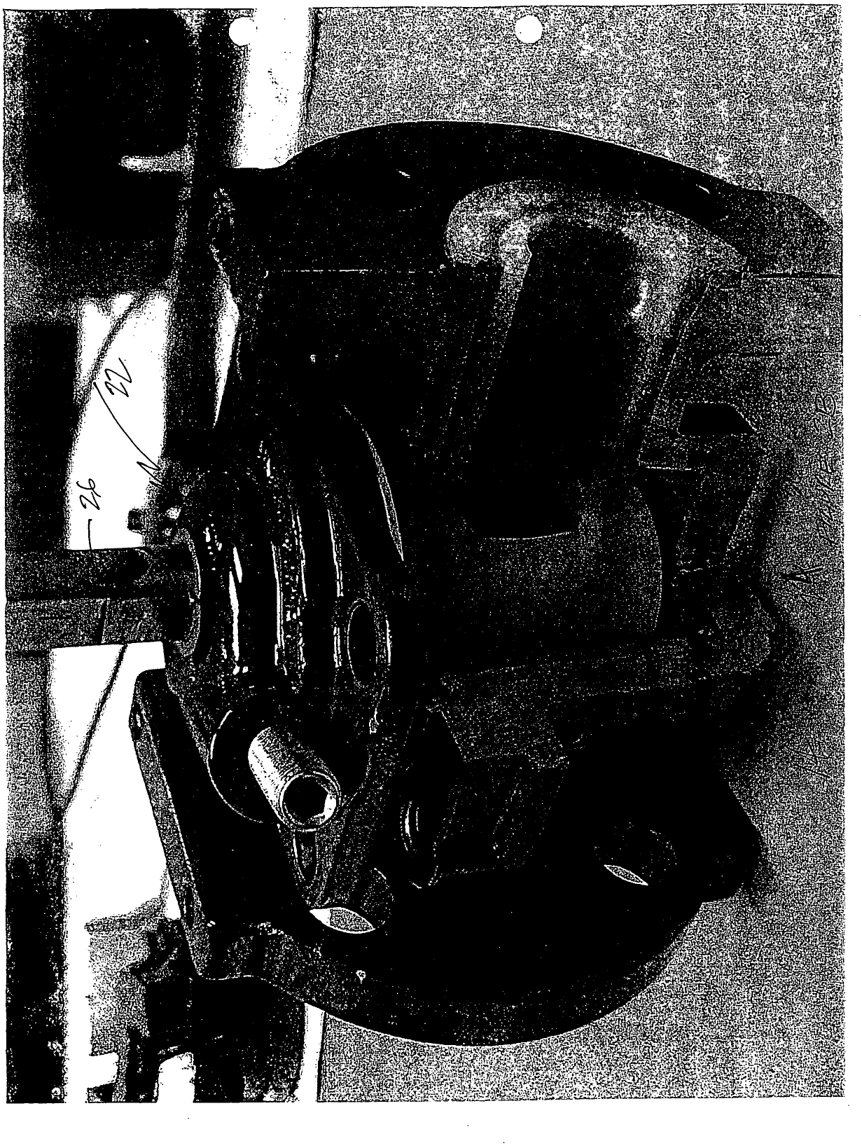

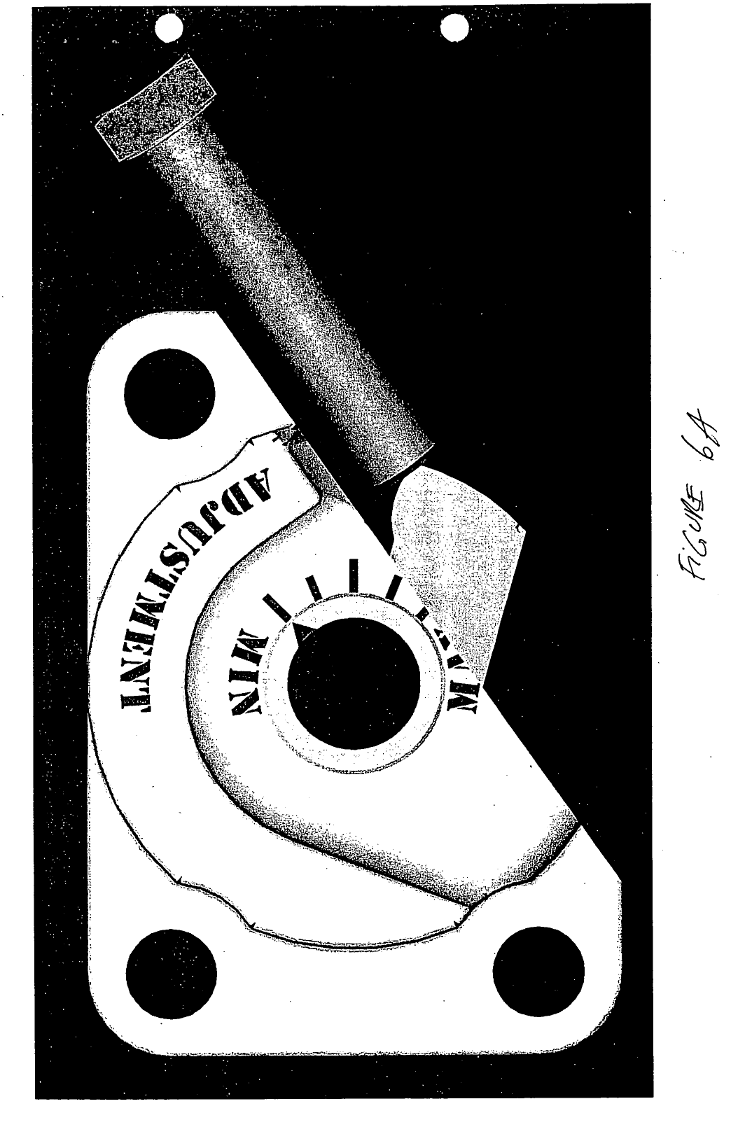

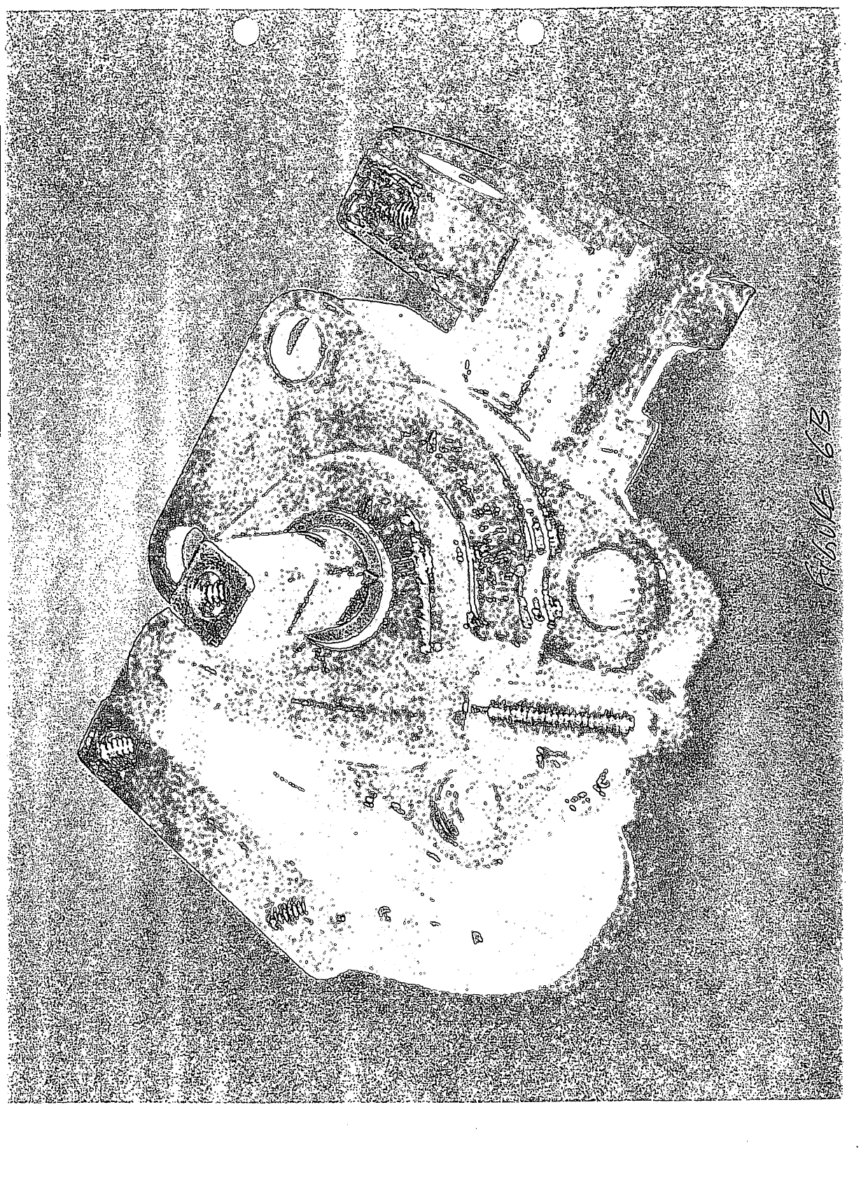

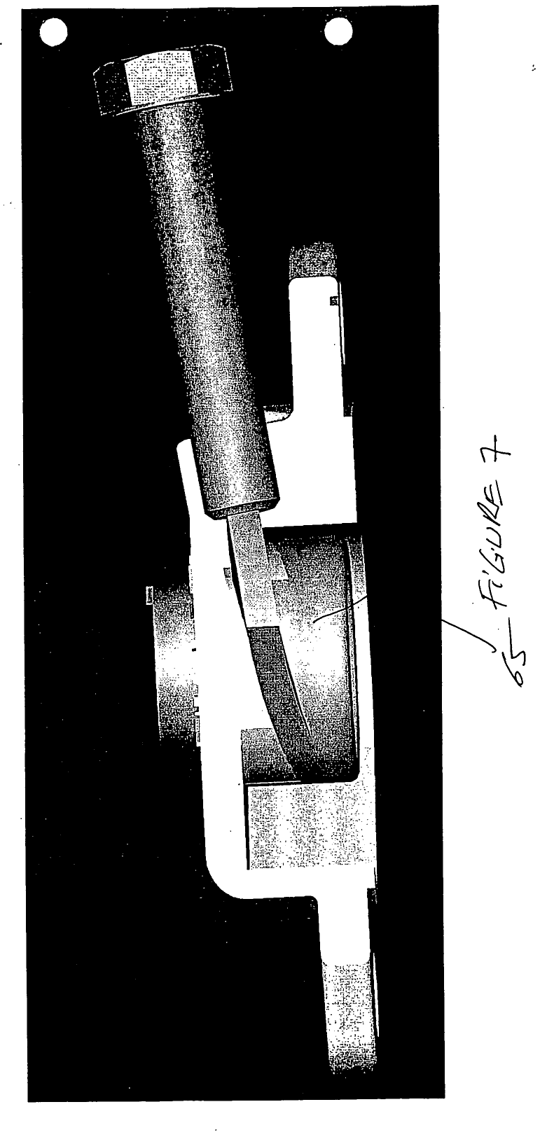

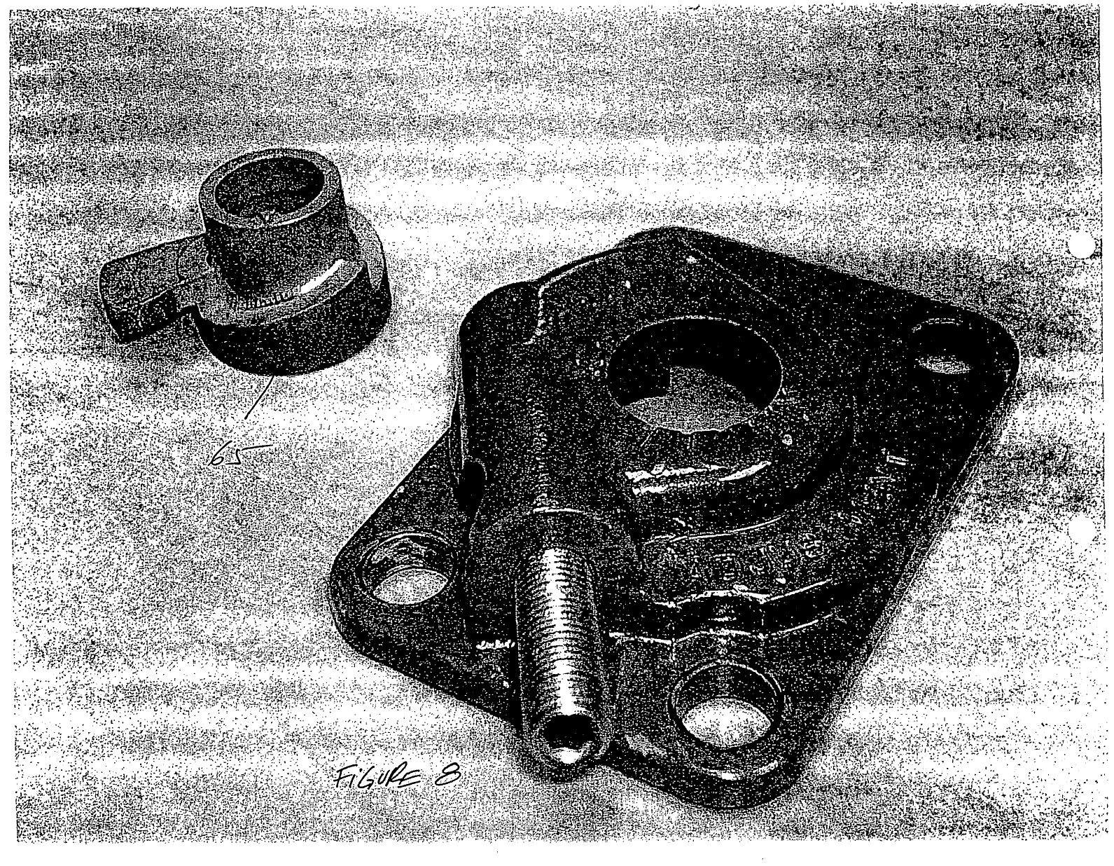

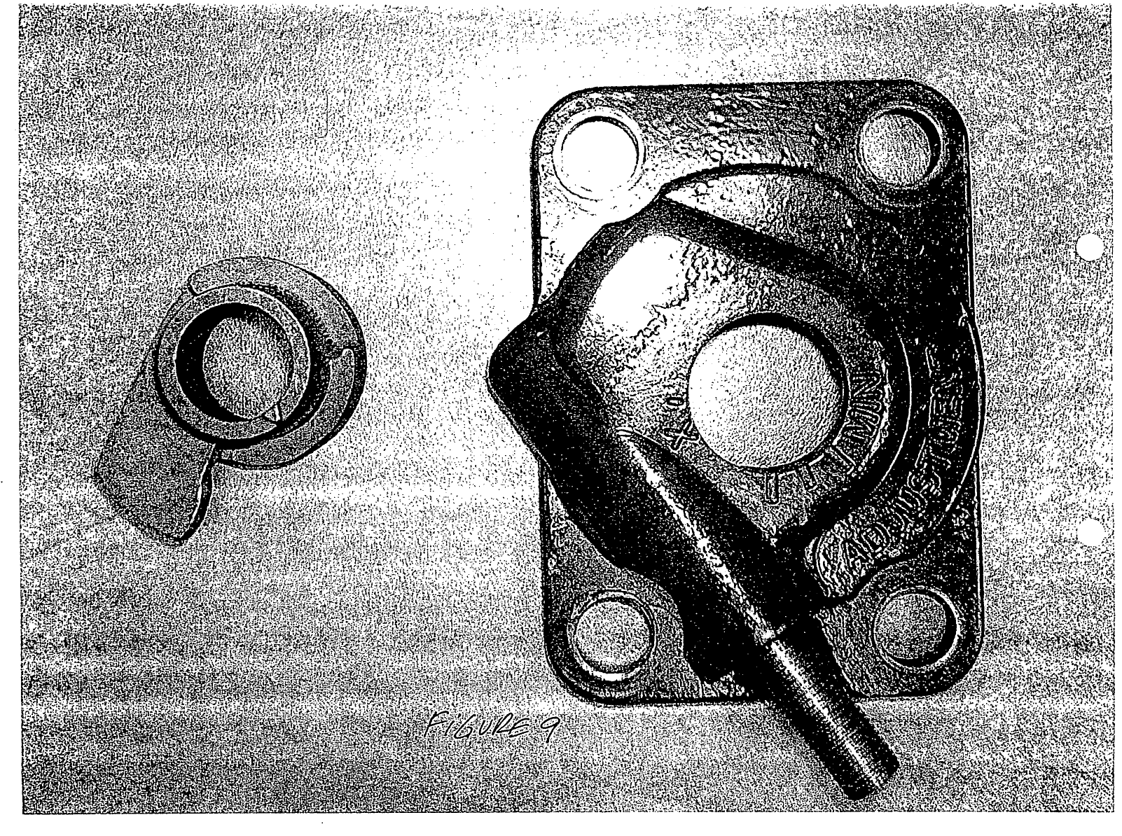

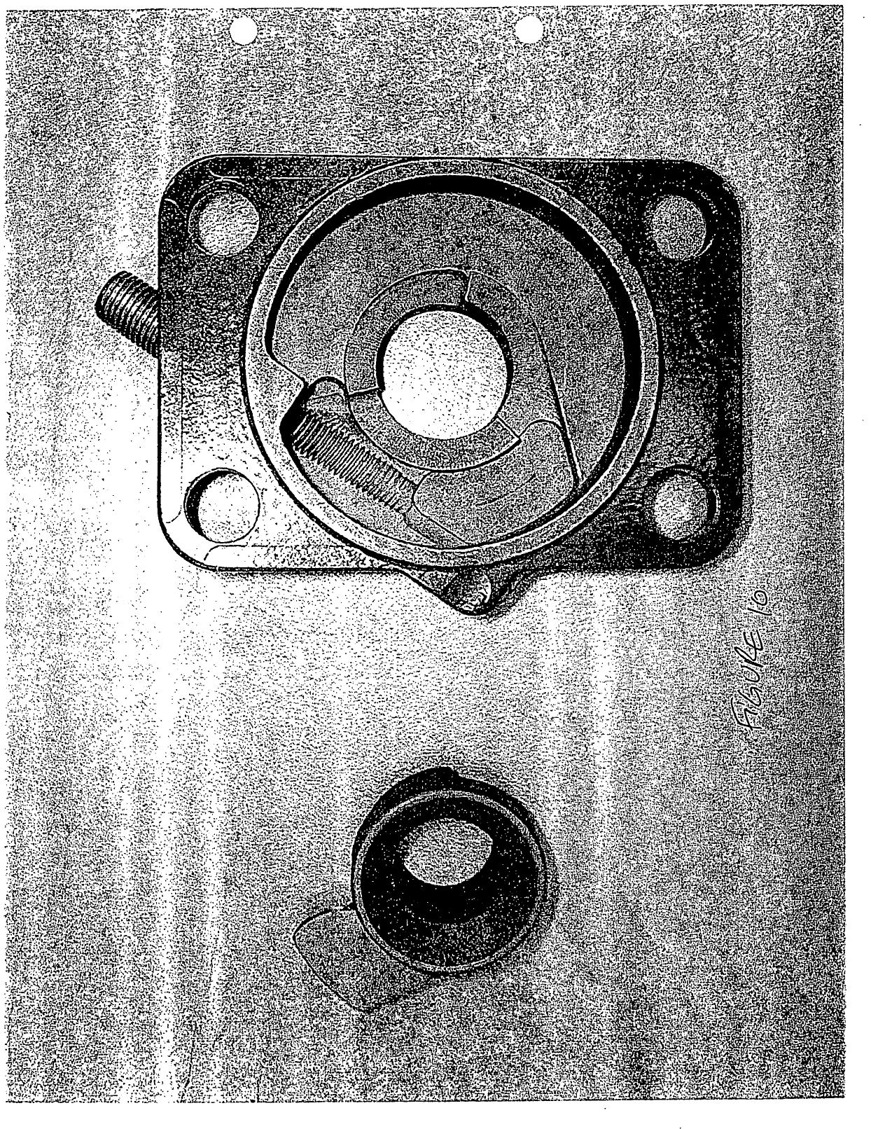

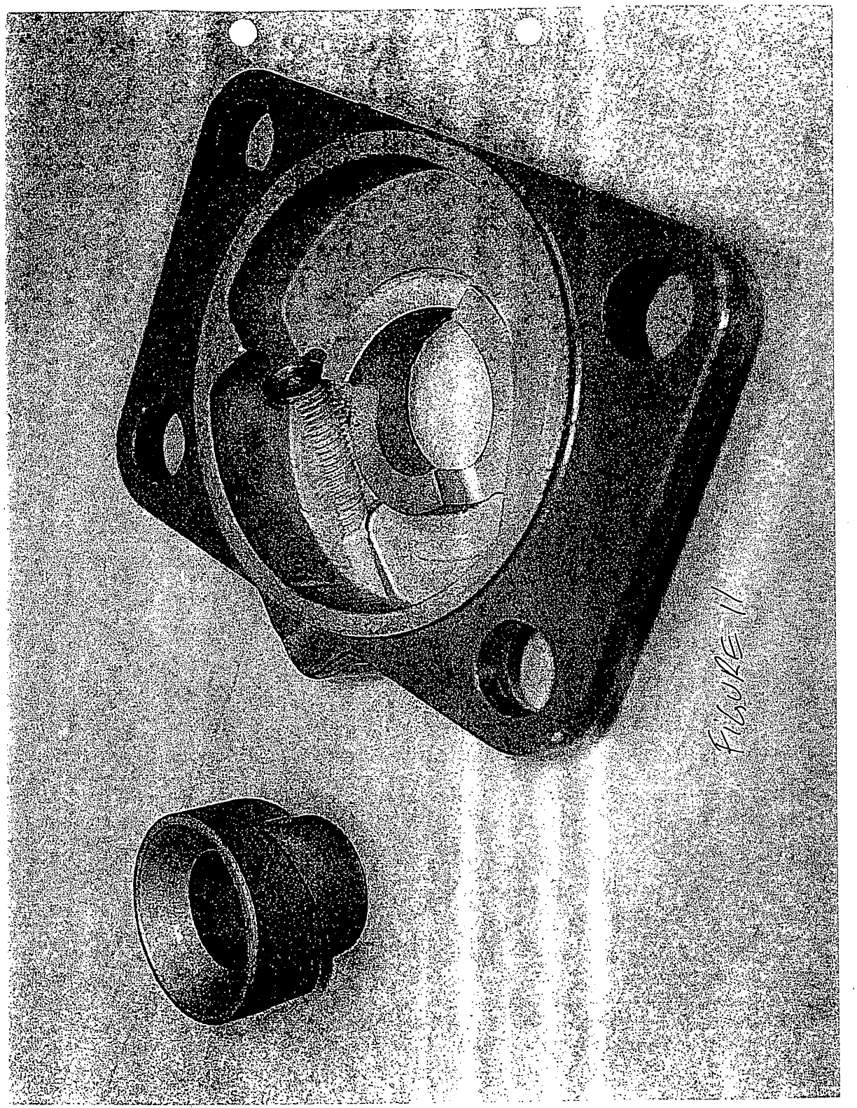

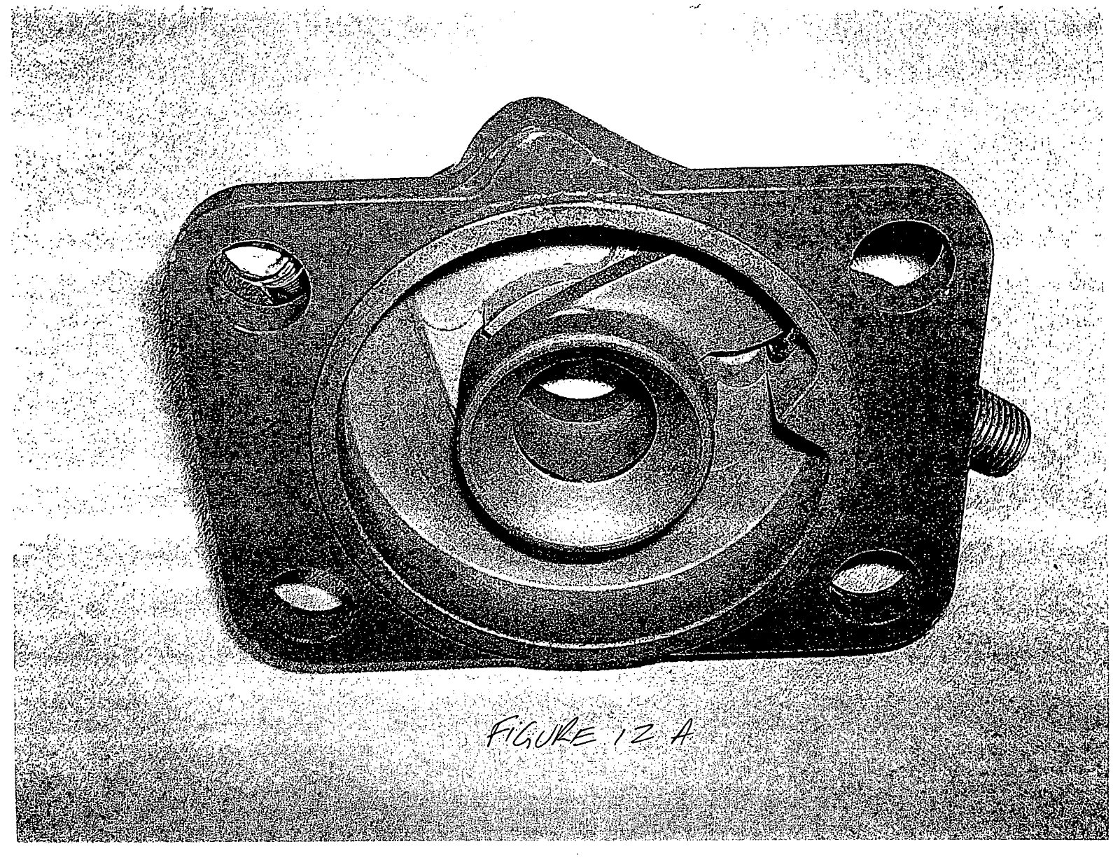

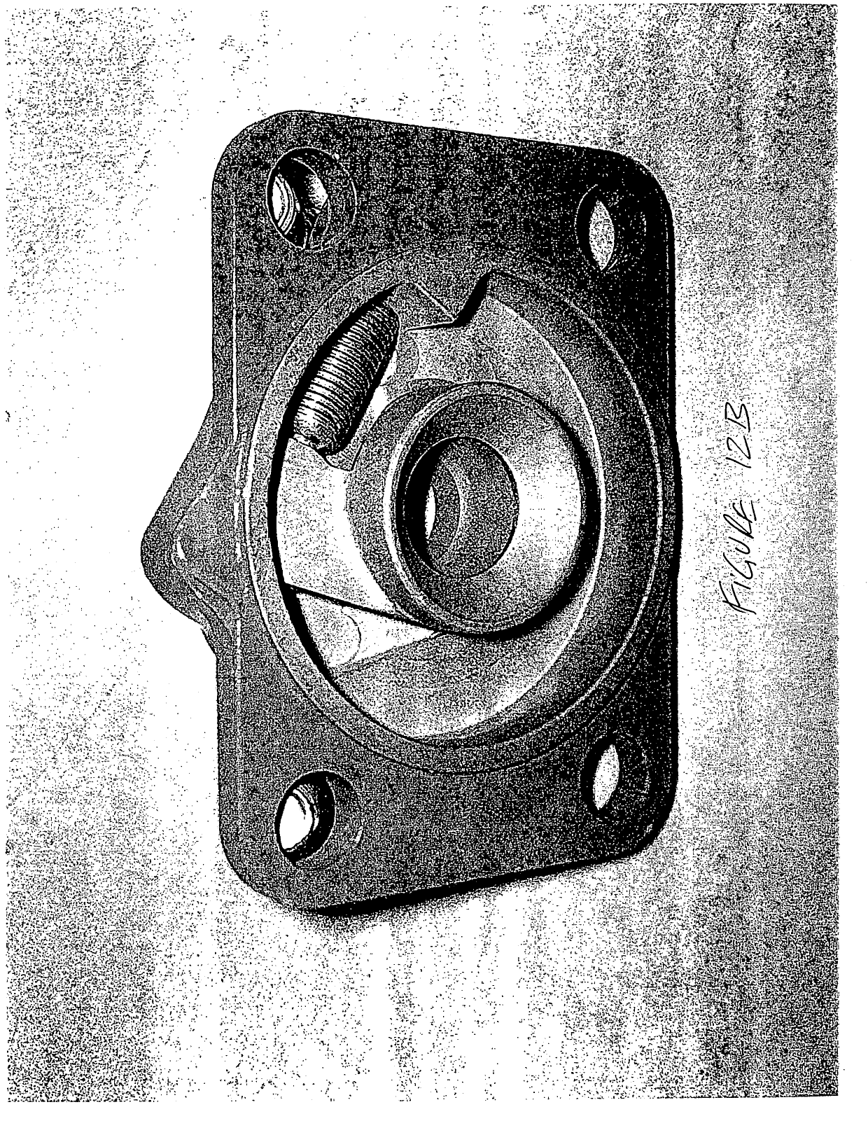

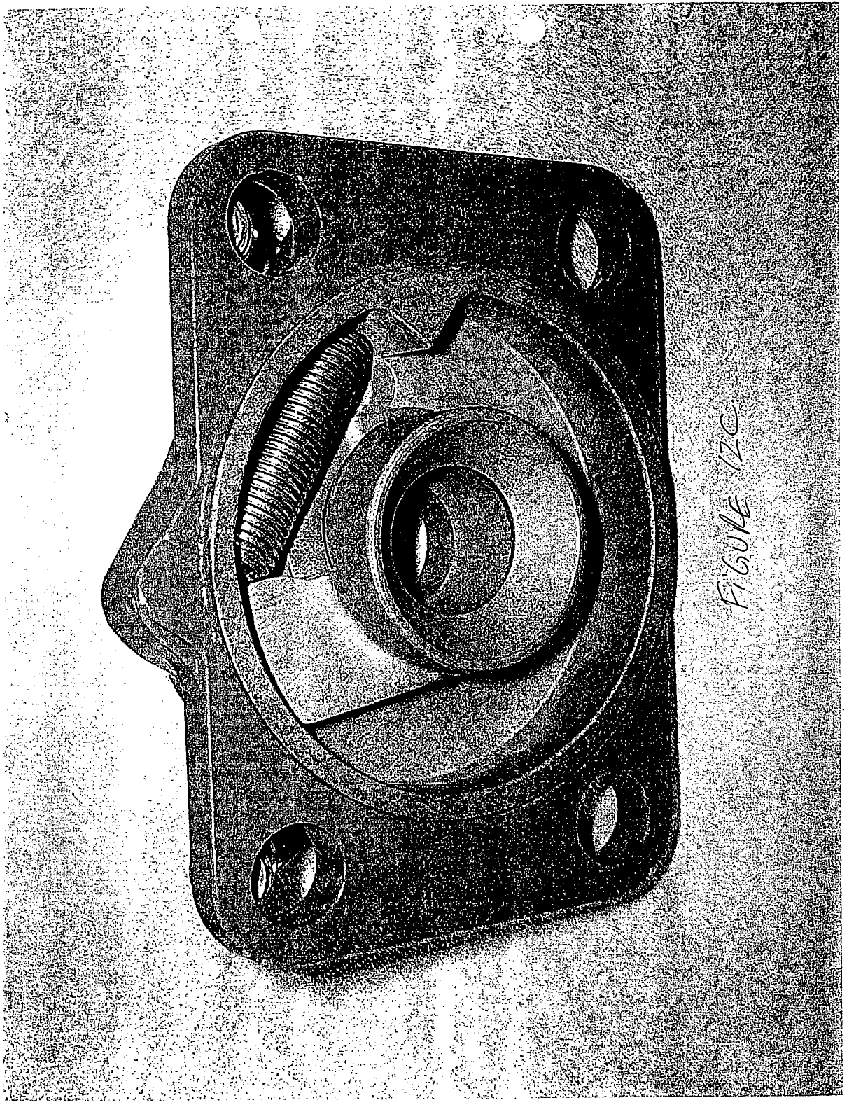

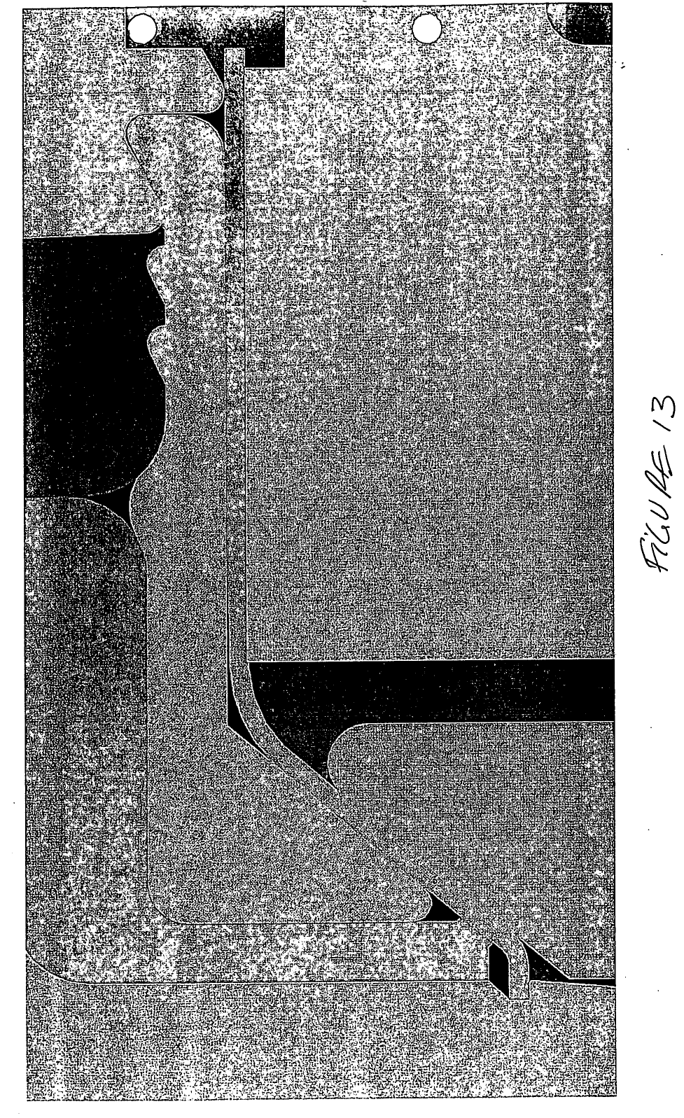

Referring now to the drawings and to FIGS. 1A and 2B in particular, a plug valve 10 constructed in accordance with the present invention is shown. The plug valve 10 includes a valve body 14 having an inlet 16 and an outlet 18 with an internal flow passage 20 extending therebetween. A rotatable valving member 22 extends across the internal flow passage 20 to selectively block fluid flow therethrough. This valving member 22 is rotatably disposed within the valve body 14 of the illustrated embodiment and has a plug portion 24 which extends across the flow passage 20. A stem portion 26 of the rotatable valving member 22 is integrally attached to the plug portion 24 to extend out of the valve body 14. Under normal circumstances, the stem portion 26 is interconnected with an actuator (not shown, either manual or automatic) which transmits a torque to the valving member 22 to effectuate relative rotation of the valving member 22 relative to the valve body 14 along a rotational axis 28.

The plug portion 24 of the valving member 22 has a through opening or passageway 30 therein, as is usual, to be placed in and out of registry with the internal flow passage 20 incident to partial rotation of the valving member 22 about the axis 28. In the illustration of FIG. 2B, the valving member 22 is shown in an open position. In this open position, the passageway 30 through the plug portion 24 registers with the internal flow passage 20. As should be readily apparent, the valving member 22 is designed to be rotated about this axis 28 to place its through passageway 30 out of registry with the valve housing's (14) internal flow passage 20 and to completely cut off flow through that internal flow passage 20.

A first or primary sealing member in the form of a sleeve or liner formed of a fluorinated hydrocarbon polymeric material such as polytetrafluoroethylene, sold under the trademark TEFLON, or equivalent material is preferably fitted about the periphery of the plug portion 24 of the valving member 22 and is aperatured in correspondency to that plug portion 24 to permit registry of the plug portions (24) through passageway 30 with the internal flow passage 20 whenever valving member 22 is in the open position illustrated in FIG. 2B. The sealing member is snugly fitted on opposite sides of the internal flow passage 20 and provides a seal between the plug portion 24 of the valving member 22 and the valve body 14.

As mentioned above, the stem or shaft portion 26 of the valving member 22 extends out of the body 14. In the illustration of FIG. 2B, this extension is through an opening in the top of the valve body 14, and for purposes of the present description, this opening will be referred to as a top opening (although the valve could clearly be oriented differently). This top opening is covered with a top seal in a form of a diaphragm 38 which is aperatured to accommodate the stem portion of the valving member 22 which passes through the diaphragm 38. The diaphragm 38 will initially be described as having been formed of a fluorinated hydrocarbon polymer such as polytetrafluoroethylene or equivalent material. However, as will be highlighted below, the design of the diaphragm is such to permit the use of a wide range of materials to meet a correspondingly wide range of applications.

The top seal 38 and the cooperating components of the valve 10 with which it interacts allow movement between the valve body 14 and the plug 22 to occur without interrupting the seal provided by the top seal 38. Plug portion 22 has a taper of approximately from the top of the plug (proximal to stem 26) to the lower portion of the plug (distal to the stem 26). This taper of the plug 26 allows for downward adjustability of the plug by increasing the pressure of tightening bolt 65. Downward adjustment of plug 22 relative to the body 14 increases the service pressure of the valve 10, permitting use of higher pressurized media without leakage. Increasing the surface pressure of the valve also increases the torque required to rotate the plug 22 relative to the body 14.

Tightening of the seal tightening cam 65 applies a downward force on the thrust collar. This downward force is principally applied to the obliquely oriented bearing surface 54 which, in turn, applies a force to the rotatable valving member 22 in a direction substantially perpendicular to that of the bearing surface 54. The result in the force applied to the rotating valving member 22 has two components, a first downward component in the direction of arrow 70 and a second horizontal component in the direction of arrow 72. The two resulting components of force urge the top seal 38 in sealing engagement with both the stem portion 26 and the shoulder of the rotatable valving member.

Thus, it is apparent that there has been provided, in accordance with the invention, a top seal that fully satisfies the objects, aims and advantages set forth above. While the invention has been described in conjunction with a specific embodiment thereof, it is evident that many alternatives, modifications, and variations will be apparent to those skilled in the art in light of the foregoing description. Accordingly, it is intended to embrace all such alternatives, modifications, and variations as fall within the spirit and broad scope of the amended claims.

1. A plug valve adjustment means comprising a cam which is adjustable using a single bolt or screw.
